(19) United States
(12) Patent Application Publication
(10) Pub. No.: US 2012/0233450 A1
(43) Pub. Date: Sep. 13, 2012

(54) SYSTEM AND METHOD OF BOOTING A COMPUTER SYSTEM USING AN EFI PERSONALITY OF A DIFFERENT COMPUTER SYSTEM

(76) Inventors: Terry Ping-Chung Lee, Antelope,, CA (US); Sriram Narasimhan, Cupertino, CA (US)

(21) Appl. No.: 13/386,681

(22) PCT Filed: Nov. 30, 2009
(86) PCT No.: PCT/US09/66076

§ 371 Date: Jan. 24, 2012

(51) Int. Cl. G06F 9/24; G06F 15/177

(52) U.S. Cl. 713/2

(57) ABSTRACT

Booting a computer system using an EFI personality of a different computer system. At least some of the illustrative embodiments are methods including: reading, by a first computer system, a plurality of parameters of an EFI personality of a second computer system different than the first computer system; modifying, by the first computer system, a first parameter of the plurality of parameters thereby creating a modified EFI personality; and booting an operating system on the first computer system based on modified EFI personality.

### BACKGROUND

Computer companies attempt to design server systems such that as an individual server experiences hardware and/or software difficulties, a second server takes over the operations of the first server. In systems where each server is operated under the extensible firmware interface (EFI) specification and the servers are identical, the second server may be booted using the EFI parameters of the first server (i.e., booted using the EFI personality of the first server).

### BRIEF DESCRIPTION OF THE DRAWINGS

For a detailed description of exemplary embodiments, reference will now be made to the accompanying drawings in which:

FIG. 1 shows a system in accordance with at least some embodiments;

FIG. 2 shows a logic relationship of various components in accordance with at least some embodiments;

FIG. 3 shows a computer system in accordance with at least some embodiments; and

FIG. 4 shows a method in accordance with at least some embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function.

In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

“Extensible firmware interface (EFI) personality” shall mean one or more parameters, defined by the EFI specification, where the parameters are used at least during booting of the operating system by a computer system operated under the EFI specification.

“Virtual machine” shall mean an operating system instance on the computer system, where the operating system instance is able to share underlying physical hardware of the computer system with other operating system instances. The operating system instances, in some cases, are hosted by an underlying operating system.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

The various embodiments are directed to systems and methods of booting computer systems with the extensible firmware interface (EFI) personality of another computer system, where the computer systems are heterogeneous. Stated otherwise, the various embodiments are directed to booting computer systems with the EFI personality of another computer system, but prior to booting programmatically modifying the EFI personality to account for differences in EFI personality between the computer systems. This specification first turns to an overall architecture of an illustrative server system in which the systems and methods may be practiced.

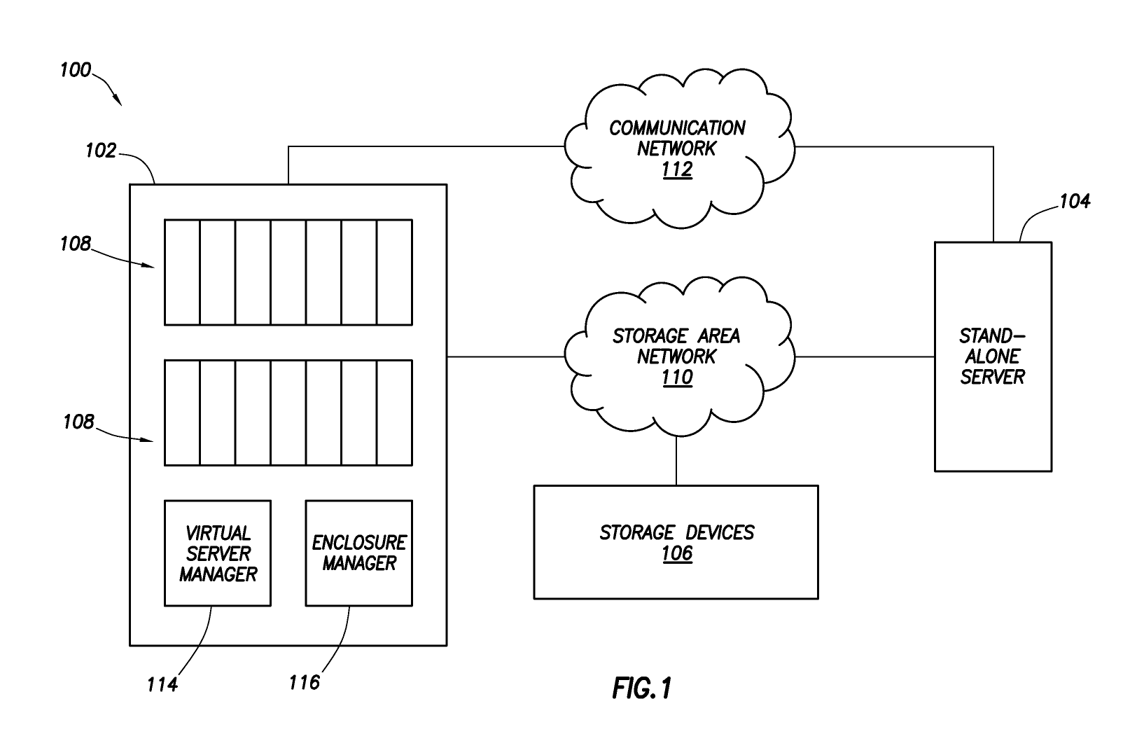

FIG. 1 illustrates a system 100 in accordance with at least some embodiments. In particular, the illustrative system 100 comprises a server enclosure 102, a stand-alone server computer system 104 (hereafter just stand-alone server 104) and a set of network accessible storage devices 106. Server enclosure 102 comprises a plurality of “blade” server computer systems 108 (hereafter just blade servers 108). A blade server is a computer system implemented as a single unit that is connected, both physically and electrically, within the enclosure by telescopically inserting the blade server into a slot of the server enclosure 102. Server enclosure 102 is shown to support fourteen such blade servers 108, but any number of blade servers may reside within an enclosure. While each blade server 108 has one or more processors and memory devices (e.g., random access memory (RAM)), because of the form factor the blade severs may not internally implement long term storage devices, such as disk drives. Regardless of whether a blade server 108 has internally implemented long term storage devices, blade server 108 couples to the storage devices 106 by way of the storage area network (SAN) 110 (e.g., a Fibre Channel Network). In order to perform useful work for entities outside the enclosure 102, the blade servers 108 couple to a communication network 112, such as an Ethernet® network coupled to the Internet.

The server enclosure 102 further comprises a virtual server manager computer system 114 (hereafter just virtual server manager 114) and an enclosure manager computer system 116 (hereafter just enclosure manager 116). As will be discussed in more detail below, the virtual server manager 114 is a central repository for EFI personalities, and controls the EFI personalities under which servers boot. In the event a server needs to be booted with the personality of a failed server, the EFI personality is retrieved from virtual sever manager 114 and provided to the newly selected server. The enclosure manager 116 performs functions related to overall server enclosure 102 management (e.g., monitoring central power supplies, powering-on and powering-off blade servers), and also plays a role in booting of servers with particular EFI personalities. The virtual server manager 114 and enclosure manager 116 are computer systems, but in some embodiments have a different form factor and/or computing capability than the blade servers 108.

Still referring to FIG. 1, and particularly the stand-alone server 104. In some embodiments, the stand-alone server 104 is a single computer system within a dedicated enclosure separate from the server enclosure 102, and the stand-alone server 104 comprising a dedicated power supply and in some cases internal long term storage devices. The stand-alone server 104 couples to the storage devices 106 by way of the storage area network 110. Finally, the stand-alone server 104 may also couple to the communication network 112.

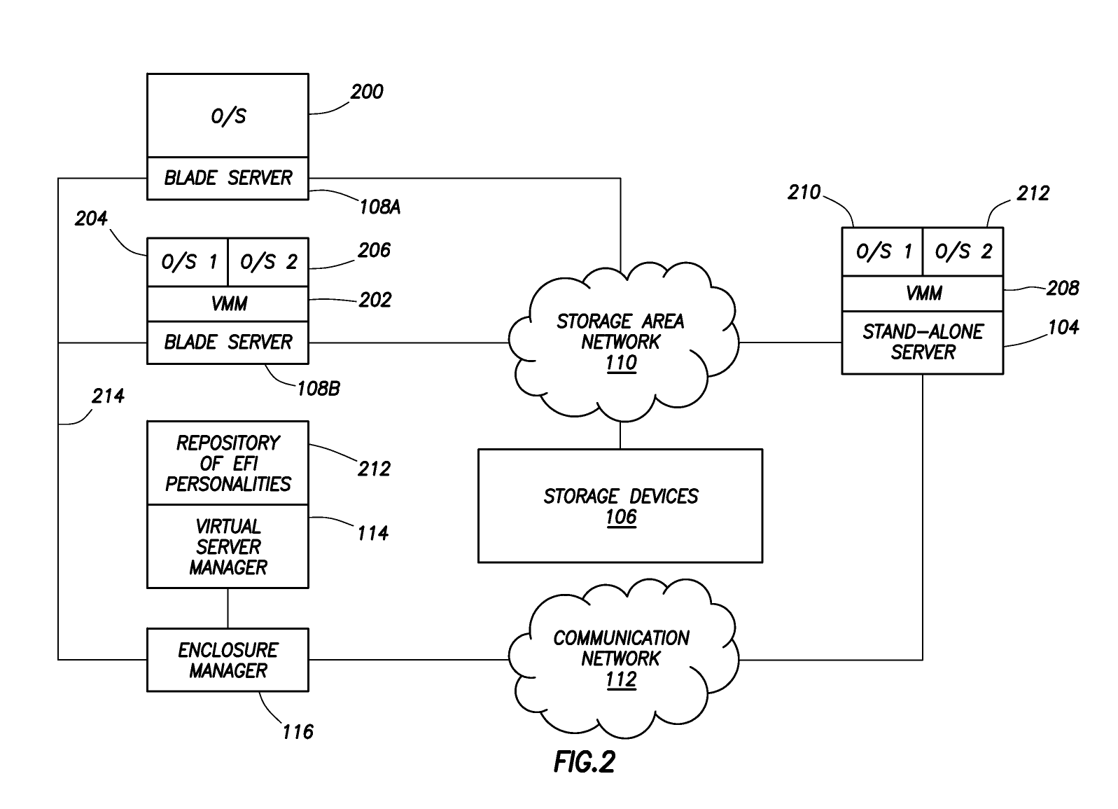

While FIG. 1 shows an illustrative physical system, FIG. 2 shows an illustrative logical relationship between the hardware and various servers implemented in the system. In particular, FIG. 2 illustrates two types of servers: real servers; and virtual servers. A real server, for purposes of this specification and claims, is a computer system that implements a single operating system (i.e., the only operating system), and does not share the underlying hardware of the computer system with another operating system. In FIG. 2, blade server 108A illustrates a single operating system 200 executed on the blade server that does not share the blade server 108A hardware with another operating system. Stated otherwise, illustrative blade server 108A has an operating system booted therein such that no virtual servers (also known as virtual machines) operate on the blade server 108A. The functionality provided by the blade server 108A with its illustrative single operating system 200 can be any suitable functionality, such as a web server providing requested web pages of a company or an online commerce server.

However, in some situations the operators of a server system may find beneficial the principle of operating a plurality of virtual servers on an underlying blade server hardware. FIG. 2 illustrates the virtual server implementations with respect to blade server 108B. In particular, blade server 108B is shown to have virtual machine monitor (VMM) 202 program executing on the underlying hardware of the blade server. The virtual machine monitor, sometimes referred to as a hypervisor, provides support for booting multiple operating systems, with each operating system implementing a virtual server. As illustrated, two operating systems, operating system 1 (O/S 1) 204 and operating system 2 (O/S 2) 206, are operational on the blade server 108B, and thus the blade server 108B implements two virtual servers. Two or more virtual servers may be implemented on a computer system, depending on the computing capability of the underlying hardware. Illustrative virtual machine monitor 202 programs include VMware ESX Server from VMware, Inc. of Palo Alto, Calif., and Hyper-V from Microsoft Corporation of Redmond, Wash.

Still referring to FIG. 2, the stand-alone server 104 may likewise implement virtual servers, as illustrated by the stand-alone server 104 executing a virtual machine monitor 208, along with an illustrative two operating systems 210 and 212. Having the stand-alone server 104 implement multiple virtual servers is merely illustrative, and in some embodiments the stand-alone server 104 operates as a real server.

In accordance with the various embodiments, the physical servers (blade servers 108 and stand-alone sever 104) operate under the extensible firmware interface (EFI) specification. The EFI specification utilizes a software interface between the operating system and the underlying physical hardware of a system. The EFI specification is managed by the Unified EFI Forum operated as an alliance between many computer system manufacturers, including Hewlett-Packard Company. Information on the EFI specification may be found on the Unified EFI Forum website at www.UEFI.org.

The EFI specification defines a plurality of parameters used by the underlying hardware during booting of the operating system, and likewise during operation. The parameters defined by the EFI specification and used by the underlying hardware are referred to, as a group and for a single machine (whether “real” or “virtual”), as an EFI personality. An illustrative, and non-exhaustive, list of parameters of an EFI personality includes an indication of a communication path to a boot device, and one or more flags regarding whether the underlying hardware is enabled for multi-threaded operation.

In accordance with the various embodiments, each server (whether “real” or “virtual”) is configured to provide its EFI personality to a central repository. For example, each virtual server (illustrated by respective operating systems 204, 206) on blade server 108B has an EFI personality, and each EFI personality is reported to a central repository. Each EFI personality may be reported on a timed basis, reported each time there is a change to any parameter of the EFI personality, or both. Referring again to FIG. 2, in accordance with at least some embodiments the central repository 212 for EFI personalities is accessible through the virtual server manager 114. In some cases, the virtual server manager 114 has internal non-volatile storage (e.g., disk drives) where the repository 212 of EFI personalities is stored. In yet still other embodiments, the virtual server manager 114 may couple to the storage area network 110, and thus the repository for the EFI personalities may be within the storage devices 106. The virtual server manager 114 is merely illustrative of a computer system implementing the repository 212 of EFI personalities. Any computer system communicatively coupled to the blade servers 108 and/or stand-alone server 104, including computer systems outside the enclosure 102, may be the repository 212 of EFI personalities.

In the case of the blade servers 108 within the server enclosure 102, the EFI personalities may be reported to the virtual server manager 114 by way of an internal management network 214 (e.g., Ethernet network), where the management network 214 resides solely within the server enclosure 102. As illustrated, the blade servers 108 couple to the management network 214, the management network 214 couples to the enclosure manager 116, and the virtual server manager 114 couples to the enclosure manager 116. Thus, the enclosure manager 116 participates in providing the EFI personalities to the repository 212. In other embodiments, the virtual server manager 114 may couple directly to the management network 214.

Still referring to FIG. 2, in accordance with at least some embodiments, the illustrative virtual server manager 114 not only implements the repository 212 for blade servers 108 within the server enclosure 102, but also implements the repository for servers outside the server enclosure 102, such as blade servers in other enclosures and stand-alone servers (e.g., stand-alone server 104). Using stand-alone server 104 as illustrative of all servers external to the server enclosure 102, just like the internal servers, stand-alone server 104 in accordance with the various embodiments reports the one or more EFI personalities to the repository 212. In particular embodiments the operation system of the stand-alone server 104 is configured to send the EFI personality. In other embodiments, particularly embodiments were the stand-alone server 104 implements virtual servers, the virtual machine manager 208 is configured to report the EFI personalities. Because in some embodiments the management network 214 does not extend outside the server enclosure 102, the stand-alone server 104 may report the one or more EFI personalities to the repository 212 by way of the communication network 112 and enclosure manager 116. In other embodiments, the virtual server manager 114 may couple directly to the communication network 112, thus obviating the need for the enclosure manager to act as an intermediary in the communications. In yet still further embodiments, the management network 214 is extended beyond the server enclosure 102, the stand-alone server 104 couples directly to the management network 214, and the stand-alone server 104 reports its one or more EFI personalities over the management network.

In accordance with the various embodiments, the virtual server manager 114 not only implements the repository 212 of EFI personalities, but also controls the EFI personality under which a particular operating system is allowed to boot. Consider, as an example, that the server implemented by the operating system 200 on blade server 108A fails. The virtual server manager 114, upon becoming aware of the failure may select a different blade server 108, or even an external server (e.g., stand-alone server 104), to take the place of the failed server. In accordance with the various embodiments, the virtual server manager 114 provides the EFI personality of the failed server to the newly selected server, the newly selected server reads and/or is accepts the EFI personality, and the newly selected server boots under the EFI personality of the failed server.

However, in accordance with the various embodiments, the virtual server manager 114 is not limited to the newly selected server being homogenous, from a hardware perspective, with the failed server. Stated otherwise, in accordance with the various embodiments the virtual server manager 114 may request non-identical computer system hardware to boot under the EFI personality of the failed server. What is more, and still in accordance with the various embodiments, the virtual server manager 114 may request a virtual server to boot using the EFI personality of a failed real server, and vice versa. In order for heterogeneous device to boot the EFI personality of the failed server, certain portions of the EFI personality are programmatically modified. An explanation of the modifications that may be needed requires a diversion into an exemplary set of computer system internal components.

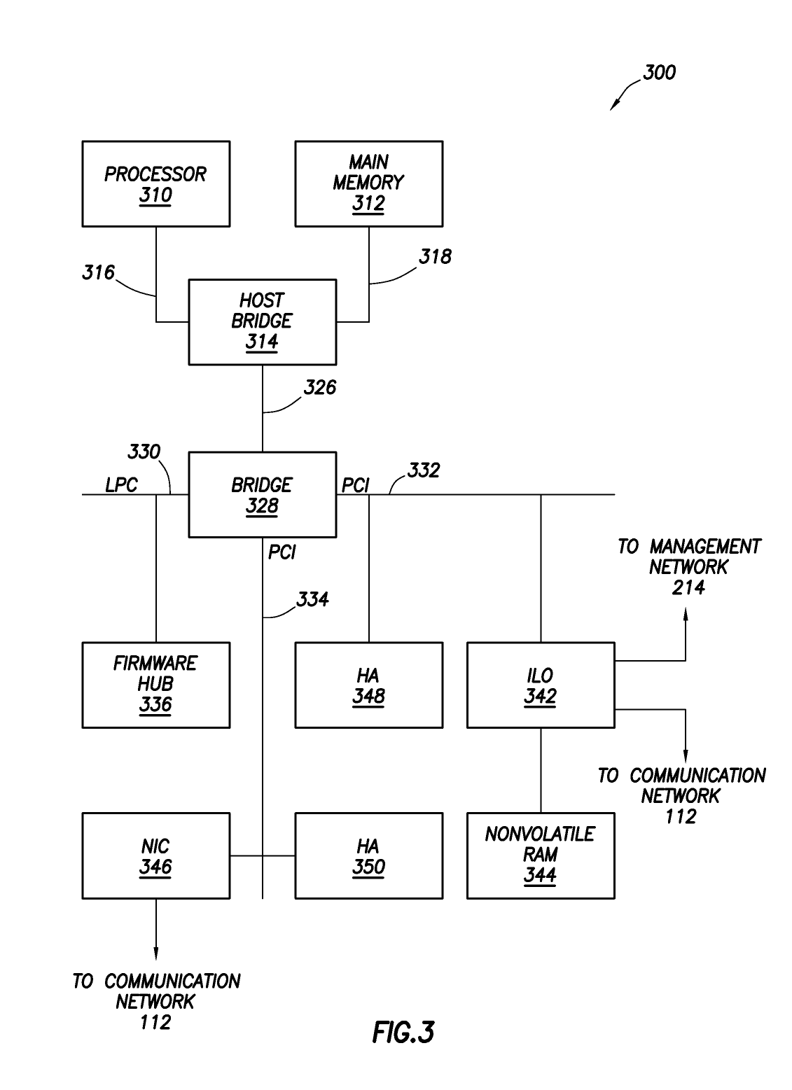

FIG. 3 illustrates a computer system 300 in accordance with at least some embodiments, and computer system 300 is illustrative of any computer system of the system 100 of FIG. 1. In particular, computer system 300 comprises a main processor 310 coupled to a main memory array 312, and various other peripheral computer system components, through integrated host bridge 314. The processor 310 may be a single processor core device, or in other embodiments a processor implementing multiple processor cores. The main processor 310 couples to the host bridge 314 by way of a host bus 316, or the host bridge 314 may be integrated into the main processor 310. Thus, the computer system 300 may implement other bus configurations or bus-bridges in addition to, or in place of, those shown in FIG. 3.

The main memory 312 couples to the host bridge 314 through a memory bus 318. Thus, the host bridge 314 comprises a memory control unit that controls transactions to the main memory 312 by asserting control signals for memory accesses. In other embodiments, the main processor 310 directly implements a memory control unit, and the main memory 312 may couple directly to the processor 310. The main memory 312 functions as the working memory for the processor 310 and comprises a memory device or array of memory devices in which programs, instructions and data are stored. The main memory 312 may comprise any suitable type of memory such as dynamic random access memory (DRAM) or any of the various types of DRAM devices such as synchronous DRAM (SDRAM), extended data output DRAM (EDODRAM), or Rambus DRAM (RDRAM). The main memory 312 is an example of a non-transitory computer-readable medium storing programs and instructions, and other examples are disk drives and flash memory devices.

The illustrative computer system 300 also comprises a second bridge 328 that bridges the primary expansion bus 326 to various secondary expansion buses, such as a low pin count (LPC) bus 330, a first peripheral components interconnect (PCI) bus 332, and a second PCI bus 334. Various other secondary expansion buses may be supported by the bridge device 328. In accordance with some embodiments, the bridge device 328 comprises an Input/Output Controller Hub (ICH) manufactured by Intel Corporation, and thus the primary expansion bus 326 comprises a Hub-link bus, which is a proprietary bus of the Intel Corporation. However, computer system 100 is not limited to any particular chip set manufacturer, and thus bridge devices and expansion bus protocols from other manufacturers may be equivalently used.

Firmware hub 336 couples to the bridge device 328 by way of the LPC bus 332. The firmware hub 334 comprises read-only memory (ROM) which contains software programs executable by the processor 310. The software programs comprise not only programs to implement the EFI specification, but also instructions executed during and just after power on self tests (POST) procedures. The POST procedures as well as the memory reference code perform various functions within the computer system before control of the computer system is turned over to programs that implement the EFI specification, which EFI specification compliant programs control booting of an operating system, among other things.

Still referring to FIG. 3, computer system 300 further comprises management processor 342 illustratively coupled to the bridge device 328 by way of the first PCI bus 332. In some cases, the management processor 342 remains powered and active even when the processor 310 is powered-off, and thus the management processor 342 is often referred to as an integrated lights out (ILO) processor. The term “management processor” should not be read as limiting the functionality of the device to just that of a stand-alone processor. In some embodiments, management processor 342 is a stand-alone processor, while in other embodiments the management processor 342 is an application specification integrated circuit (ASIC) having at least one processor core, and other components (e.g., memory, and network interface devices). In yet still other embodiments, the management processor 42 is formed from a plurality of individual components grouped together physically, such as on a circuit board coupled within the computer system 300. In accordance with the various embodiments, the management processor 42 comprises multiple internal network interface controllers. One internal network interface controller enables the management processor 342 to couple to the management network 214 (FIG. 2). Another internal network interface controller enables the management processor 342 to couple to the communication network 112 (FIG. 2).

The management processor 342 in some embodiments has coupled thereto non-volatile RAM 344, within which parameters of the EFI personality used by the computer system 300 may be stored. It is noted, however, the non-volatile RAM that stores the EFI personality used to boot and operate the computer system may be coupled to other components of the computer system, such as directly coupled to another secondary expansion bus or directly coupled to the bridge device 328.

The computer system 300 further comprises a network interface card (NIC) 346 illustratively coupled to the second PCI bus 334. The NIC 346 acts as to couple the computer system 300 to a communication network, such as communication network 112 (FIG. 1). Further, computer system 300 comprises a host adapter (HA) 348. The host adapter 348 couples the computer system 300 to the storage area network 110 (FIG. 1), and thus enables programs executing on the computer system 300 to access long term storage (such as disk drives) external to the computer system 300. As illustrated, the host adapter 348 couples to the first PCI bus 332. However, the host adapter need not be coupled to the first PCI bus 332, and thus FIG. 3 also illustrates a host adapter 350 coupled to the second PCI bus 334. While possible to have multiple host adapters in a computer system, in most cases a single host adapter is present. The illustrative embodiments of FIG. 3 are merely to show that host adapter may reside in multiple locations within a computer system. Moreover, host adapters 348, 350, and for that matter network interface card 346, need not necessarily be coupled to PCI busses—any suitable expansion bus may be used to couple the host adapters and/or network interface cards to the remaining computer system 300 components.

Having the host adapters 348, 350 on different PCI buses illustrates potential differences in EFI personality as between two computer systems. Consider, as an example, that the storage area network 110 of FIG. 1 is a Fibre Channel network. In a Fibre Channel-based storage area network, all devices coupled to the storage area network 110 are connected by way of a host adapter, and each host adapter has a unique identification number. Thus, each storage device (e.g., disk drive) of the of the storage devices 106 (FIG. 1) is access by way of the unique identification number of its associated host adapter. One of the parameters of the EFI personality is an indication of a data or communication pathway to the boot device, and in cases where the boot device is within the storage devices 106, the communication pathway parameter includes the unique identification of the host adapter associated with the boot device.

However, the communication pathway parameter also includes an indication of the internal communication pathways to reach the host adapter 348, 350. Thus, in situations where the host adapter for the computer system 300 illustratively couples to the first PCI bus 332 (i.e., computer system 300 implements only host adapter 348), the communication pathway parameter of the EFI personality indicates the internal communication pathway to the host adapter is the first PCI bus 332, and the unique identification of the host adapter for the boot device. In situations where the host adapter for the computer system 300 illustratively couples to the second PCI bus 332 (i.e., computer system 300 implements only host adapter 348), the internal communication pathway parameter of the EFI personality indicates the communication pathway to the host adapter is the second PCI bus 334, and the unique identification of the host adapter for the boot device. The internal communication pathway to the host adapter is, in many cases, the only parameter of the EFI personality that needs to be changed to have the newly selected server boot using the EFI personality of the failed server when the severs are heterogeneous; however, the internal communication pathway to the host adapter is merely illustrative of the changes that may need to be made to the EFI personality to make the personality compatible with the underlying hardware.

Returning to FIG. 2, in accordance with various embodiments, before a blade server 108 or stand-alone server 104 is booted with the EFI personality of a failed or different server, the EFI personality is modified to account for differences in the underlying hardware. For example, consider again the illustrative case of the real server implemented by blade server 108A failing, and the virtual server manager 114 electing to use the stand-alone server 104 as the replacement as a real server. In such a circumstance, the virtual server manager 114 sends the EFI personality of the failed server to the stand-alone server 104. In the illustrative system of FIG. 2, the EFI personality is sent over the communication network 112 by way of the enclosure manager 116. The stand-alone sever 104, in particular the firmware of the stand-alone server 104, accepts and/or reads the EFI personality, and modifies the personality to account for differences between the stand-alone server 104 and the blade server 108 on which the personality previously ran. For example, the host adapter that couples the stand-alone server 104 to the storage area network 110 may reside on a different expansion bus than that of the blade server 108, and thus the firmware programmatically modifies the EFI personality to account for differences between the underlying hardware, but using the same boot device indication. Once modified, the firmware boots the stand-alone server 104 using the modified EFI personality.

Now consider the illustrative case of the real server implemented by blade server 108A failing, and the virtual server manager 114 electing to use the stand-alone server 104 as the replacement, but that the stand-alone server 104 is configured to implemented virtual servers. In such a circumstance, the virtual server manager 114 sends the EFI personality of the failed server to the stand-alone server 104. The stand-alone sever 104, in particular the virtual machine manager 208, accepts and/or reads the EFI personality, and modifies the personality to account for differences between the stand-alone server 104 and the blade server 108 on which the personality previously ran, as well as differences between a real and virtual server. For example, the virtual machine manager 208 programmatically modifies the EFI personality to account for differences between the underlying hardware (e.g., internal path the host adapter). In the particular case of booting as a virtual machine, some parameters of the EFI personality may be ignored (e.g., parameters related to the multi-threading capability of the underlying hardware). Once modified, the virtual machine manager boots an operating system using the modified EFI personality.

Now consider that the real server implemented by blade server 108A fails, and the virtual server manager 114 elects to use another blade server 108 as the replacement. In such a circumstance, the virtual server manager 114 sends the EFI personality of the failed server to the selected blade server, for example blade server 108B. Blade server 108B accepts and/or reads the EFI personality, and firmware executed on the blade server modifies the personality to account for differences between the blade servers. For example, the host adapter that couples blade server 108A to the storage area network 110 may reside on a different expansion bus than that of the blade server 108B, and thus the firmware programmatically modifies the EFI personality to account for differences between the underlying hardware, but using the same boot device indication. Once modified, the firmware boots the blade server 108B using the modified EFI personality.

Now consider that the real server implemented by blade server 108A fails, and the virtual server manager 114 elects to use another blade server 108B as the replacement, where blade server 108B is configured to execute virtual servers. In such a circumstance, the virtual server manager 114 sends the EFI personality of the failed server to blade server 108B. Blade server 108B accepts and/or reads the EFI personality, and the virtual machine manager 202 executed on the blade server 108B modifies the personality to account for differences between the blade servers, but again using the same boot device indication. Once modified, the virtual machine manager 202 boots an operating system instance on the blade server 108B using the modified EFI personality.

The various examples used to this point have all been the EFI personality of a real server transitioning to a real or virtual server; however, the EFI personality of a failed virtual server may likewise transition to another virtual server, or to a real server, using the same methods. Moreover, in each case the server receiving the EFI personality of the failed server has modified the EFI personality (i.e., the virtual machine manager for virtual servers, and the firmware for real servers). However, in other embodiments, the modification of the EFI personality may take place in another location. For example, in some embodiments the virtual server manager 114 may know or become aware of particular modifications that are needed for a target server, and thus may create the modified EFI server personality prior to sending the EFI personality to the target device. Likewise, in embodiments where the enclosure manager 116 participates in communicating the EFI personalities to the target devices, the enclosure manager 114 may make modifications to the personalities.

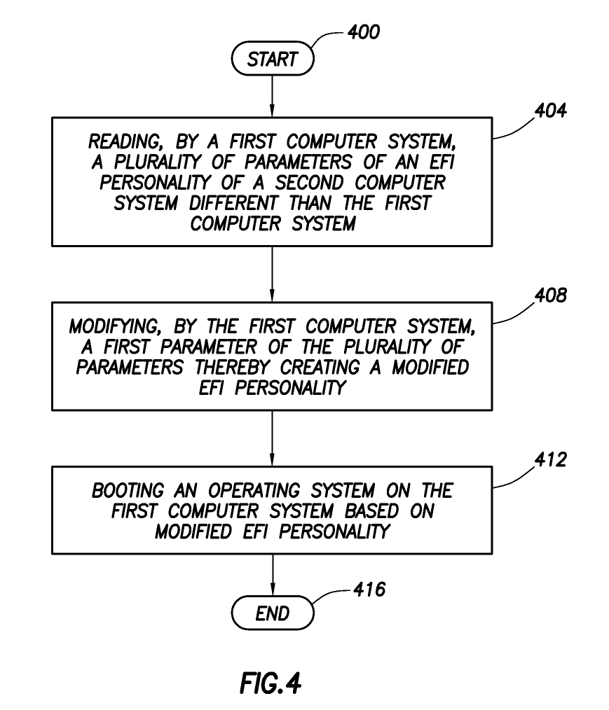

FIG. 4 illustrates a method in accordance with at least some embodiments. In particular, the method starts (block 400) and proceeds to reading, by a first computer system, a plurality of parameters of an EFI personality of a second computer system different than the first computer system (block 404). The illustrative method then proceeds to modifying, by the first computer system, a first parameter of the plurality of parameters thereby creating a modified EFI personality (block 408). Finally the method comprises booting an operating system on the first computer system based on modified EFI personality (block 412), and the method ends (block 416).

From the description provided herein, those skilled in the art are readily able to combine software created as described with appropriate general-purpose or special-purpose computer hardware to create a computer system and/or computer subcomponents in accordance with the various embodiments, to create a computer system and/or computer subcomponents for carrying out the methods of the various embodiments, and/or to create a non-transitory computer-readable storage media for storing a software program to implement the method aspects of the various embodiments.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method comprising:
reading, by a first computer system, a plurality of parameters of an extensible firmware interface (EFI) personality of a second computer system different than the first computer system;
modifying, by the first computer system, a first parameter of the plurality of parameters thereby creating a modified EFI personality; and
booting an operating system on the first computer system based on modified EFI personality.

2. The method of claim 1 wherein modifying the first parameter further comprises modifying a path parameter such that the path parameter indicates a communication pathway within the first computer system to reach an adapter that communicates with the boot device over an external network.

3. The method of claim 1 wherein reading further comprises reading the plurality of parameters of the EFI personality prior to booting any operating system on the first computer system.

4. The method of claim 1 wherein reading further comprises reading the plurality of parameters of the EFI personality by a virtual machine monitor executed on the first computer system.

5. The method of claim 1 wherein booting further comprises booting the operating system such that the operating system does not share the underlying hardware with another operating system.

6. The method of claim 1 wherein booting further comprises booting the operating system as an operating system instance of a virtual machine on the first computer system.

7. A computer-readable storage medium storing a program that, when executed by a processor of a first computer system, causes the processor to:
accept a plurality of parameters of an extensible firmware interface (EFI) personality of a second computer system different than the first computer system;
modify a first parameter of the plurality of parameters thereby creating a modified EFI personality, the modification based on a difference between the first and second computer system; and
boot an operating system instance on the first computer system utilizing the modified EFI personality.

8. The computer-readable storage medium of claim 7 wherein when the processor modifies, the program further causes the processor of the first computer system to modify a path parameter that specifies the communication pathway between the processor and a non-volatile memory device coupled to the processor.

9. The computer-readable storage medium of claim 7 wherein when the processor modifies, the program further causes the processor of the first computer system to modify a path parameter that specifies the communication pathway between the processor and a disk drive coupled to the processor by way of storage area network.

10. The computer-readable storage medium of claim 7 wherein when the processor boots the operating system instance, the program further causes the processor of the first computer system to boot an operating system such that no virtual machines operate on the first computer system.

11. The computer-readable storage medium of claim 7 wherein when the processor boots the operating system instance, the program further causes the processor of the first computer system to boot an operating system instance of a virtual machine on the first computer system.

12. A computer system comprising:
a processor;
a network adapter coupled to the processor, the network adapter configured to communicate with a storage device external to the computer system;
a memory coupled to the processor, the memory storing a program that, when executed by the processor, causes the processor to:
read, over a communication network external to the computer system, a first extensible firmware interface (EFI) personality different than an EFI personality needed to boot an operating system on the computer system;
modify a path parameter of the first EFI personality and thereby create a second EFI personality, the path parameter indicates path to a boot device for the computer system; and
boot an operating system instance on the computer system utilizing the second EFI personality.

13. The computer system of claim 12 wherein when the processor modifies, the program further causes the processor to modify a path parameter that specifies the communication pathway between the processor and a disk drive coupled to network adapter by way of storage area network.

14. The computer system of claim 12 wherein when the processor modifies, the program further causes the processor to modify a path parameter that specifies the communication pathway between the processor and the network adapter coupled to a disk drive by way of storage area network.

15. The computer system of claim 12 wherein when the processor boots the operating system, the program causes the processor to boot an operating system instance of a virtual machine on the computer system.
